(19) United States
(12) Patent Application Publication
(10) Pub. No.: US 2004/0205230 A1
(43) Pub. Date: Oct. 14, 2004

(54) Method for mapping layer-3 packets over SDH/SONET or OTN via GFP layer

(75) Inventors: Michele Fontana, Verderio Superiore (IT); Pietro Vittorio Grandi, Milano (IT); Italo Busi, Cerro Maggiore (IT)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/693,871

(22) Filed: Oct. 28, 2003

(30) Foreign Application Priority Data
Mar. 28, 2003 (EP) 03290790.9

(51) Int. Cl. G06F 15/16

(52) U.S. Cl. 709/236; 709/230

(57) ABSTRACT

The present invention provides for a method for mapping MPLS packets over Synchronous Digital Transport Networks (SDH/SONET) or Optical Transport Networks (OTN) via GFP mapping layer, through a modified PPP protocol without the LCP and NCP protocols for negotiation. In the modified PPP protocol the MPLS or IP packets are inserted, and then the GFP header is added. In order to map the modified PPP over GFP a new UPI (User Paylod Identifier) value is defined in the GFP Core header.

### TECHNICAL FIELD

The present invention relates to a method for mapping layer-3 packets over Synchronous Digital Transport Networks (SDH/SONET) or Optical Transport Networks (OTN) via GFP mapping layer.

This application is based on, and claims the benefit of, European Patent Application No. 03290790.9 filed on Mar. 28, 2003 which is incorporated by reference herein.

### BACKGROUND OF THE INVENTION

As known, MPLS is an example of network layer 3 protocol defined by IETF body in the standard RFC 3031.

According to this definition, in order to transport MPLS packets over a point-to-point (layer 1) Synchronous Digital Transport Network (SDH/SONET) or Optical Transport Network (OTN) path, a layer 2 protocol should be used.

The known PPP (Point-to-point) protocol has been selected by IETF body for MPLS transport over point-to-point lines, as described in the standard RFC 3032.

The main functionality PPP provides is “protocol multiplexing”: it allows multiple protocols above layer 2 to share the same point-to-point connection.

As also known, GFP (Generic Frame Procedure) is a mapping layer of layer 2 frames over a layer 1 SDH/SONET/OTN transport path, as currently defined in the standard ITU-T G.7041.

GFP does not provide protocol multiplexing functionality, as PPP does, and then it violates the architectural principles used in IETF when MPLS has been defined. MPLS packets can anyway be sent over GFP passing through the PPP layer.

According to ITU-T G.7041, PPP frames (encapsulating the MPLS packet or any other layer 3 packet) can be mapped into GFP and then into the SDH/SONET/OTN transport path.

Alternatively, according to IETF RFC 2615, RFC 1661 and RFC 1662, the same PPP frames can be mapped via HDLC (High level Data Link Controller) mapping layer into the SDH/SONET transport path (Packet over Sonet).

Therefore, according to the current IETF and ITU-T standards, there are two possible methods for carrying MPLS packets over SDH/SONET transport path.

Both solutions require MPLS over PPP (according to RFC 3032) and then there are two alternatives for mapping PPP over SDH/SONET transport path:

1. PPP over HDLC-like framing (RFC 1661, RFC 1662, RFC 2615)

2. PPP over GFP (ITU-T G.7041): this solution allows also the mapping over OTN.

In both cases the standard PPP solution requires to run the known protocol LCP (Link Control Protocol) according to RFC 1661 and RFC 1662, and at least the protocol MPLSCP (MPLS Network Control Protocol—NCP) according to RFC 1661 and RFC 3032. They are mainly required for interworking because of standard PPP requirements, primarily in “dynamic” connection environments, like “private dial-up” connection, where it is necessary to negotiate the network/traffic resources before connection set-up. The traffic is stopped till the end of the negotiation phase.

However, the running of LCP and NCP is not really needed when the point-to-point link is supported by an SDH/SONET/OTN transport path, where there is no need for negotiation as the connection is “static” like: in these conditions the running of LCP and NCP should introduce inefficiencies in the network throughput.

### SUMMARY OF THE INVENTION

Therefore the main object of the present invention is to provide a method for mapping layer-3 packets over Synchronous Digital Transport Networks (SDH/SONET) or Optical Transport Networks (OTN) via GFP mapping layer, which overcomes the above mentioned drawbacks.

This object is achieved by a method for mapping layer-3 packets over Synchronous Digital Transport Networks (SDH/SONET) and/or Optical Transport Networks (OTN), said method comprising the steps of:

setting up SDH/SONET and/or OTN connections over respective networks;

setting up a modified PPP protocol of PPP packets, without the LCP and NCP protocols for negotiation;

inserting the layer-3 packets in the modified PPP packet;

adding a GFP header of a GFP mapping layer to the the modified PPP packet, to get GFP packets;

setting a new value of UPI (User Paylod Identifier) field in the GFP header;

transmitting GFP packets so obtained over the SDH/SONET and/or OTN networks.

The basic idea of the present invention is to propose a modified PPP protocol without the LCP and NCP protocols for negotiation, to be preferably but not exclusively used in all application where negotiation is not required.

In the PPP protocol the layer-3 packets (like MPLS or IP) are inserted, and then the GFP header is added.

In order to map this new PPP over GFP it is required to define a new UPI (User Paylod Identifier) value in the GFP Core header (ITU-T G. 7041).

### BEST MODE OF CARRYING OUT THE INVENTION

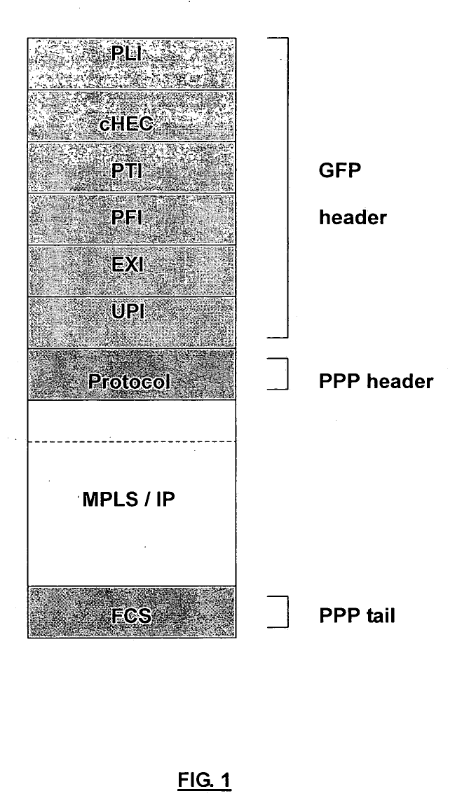

The invention will become clear from the following detailed description, given by way of a mere exemplifying and non limiting example, to be read with reference to the attached drawing FIG. 1, wherein the packet structure according to the invention is shown.

The preferred situation where the present invention applies is the point-to-point connection transmission system using Synchronous Digital Transport Networks (SDH/SONET) or Optical Transport Networks (OTN), made of a number of interconnected nodes.

The target is to map layer-3 MPLS or IP packets over SDH/SONET or OTN networks via GFP mapping layer, in such a way as to avoid the activation of the LCP and NCP negotiation protocols.

The basic idea of the present invention is to propose a modified PPP protocol without the LCP and NCP protocols for negotiation, to be preferably but not exclusively used in all applications where negotiation is not required. In the modified PPP protocol the MPLS or IP packets are inserted, and then the GFP header is added.

The point-to-point connections between nodes are established according to the known SDH/SONET or OTN criteria.

At the nodes the properties and parameters of the modified PPP protocol are configured, as well as the network protocol (IP address) through the Network Management system TMN of the SDH/SONET or OTN networks.

Then at the nodes the fields of the GFP layer are inserted.

The packets so obtained are transmitted over SDH/SONET or OTN networks in a known way.

The various fields of the overall packet are shown in FIG. 1.

A layer-3 packet, like MPLS or IP, is encapsulated into the modified PPP layer, having:

a PPP header, field Protocol, the value of which identifies the type of payload: this can be any of the layer 3, i.e. MPLS or IP or IPX or IPv6;

the said payload, i.e. an MPLS or IP packet comprising in turn an header and a payload part;

a PPP tail, field FCS, used for error checking of the PPP packet.

Then the GFP header is built up with the following fields:

PLI: payload length indication;

HEC: Header Error Check, with the following possibilities:

cHEC: core HEC, check on the Header field;

tHEC: type HEC, check on the Type field;

eHEC: extension HEC, check on the Extension header;

PTI: Payload Type identifier;

PFI: Payload FCS identifier;

EXI: Extension Header identifier;

UPI: User Payload identifier: in order to map the new PPP over GFP it is required to define a new UPI (User Paylod Identifier) value in the GFP Core header (ITU-T G. 7041), which identifies the new kind of PPP packet.

Normally the fields PFI and EXI are put at Ø.

With a different value of EXI field it is possible to add an extension header to the basic GFP: this should allow for example to put more than one different GFP channels in the same SDH/SONET Virtual Container.

With PFI=1, it is possible to add an FCS field of the GFP level at the bottom of the overall packet; in the normal situation this is not necessary, as an FCS field of the PPP level is already present.

Another possibility is to set EXI field at a given different value; then to set the UPI field at a different value with respect to above. This should allow to consider that the value of protocol type has to be read in the GFP Extension Header. Then an HEC field is put in the GFP extension header, and the layer 3 packet is inserted, and at the bottom an GFP FCS field. With PFI=1, the result is that the PPP layer is hidden in the GFP layer.

With the above described procedure, the activation of the LCP and NCP negotiation protocols is not necessary.

Further implementation details will not be described, as the man skilled in the art is able to carry out the invention starting from the teaching of the above description.

From the above description, the advantages of the present invention are clear, namely:

To avoid the usage of negotiating protocols when not necessary.

Robust solution because GFP based.

Valid for both Sonet/SDH and OTN

Standard compliant for interoperability purpose.

Many changes, modifications, variations and other uses and applications of the subject invention will become apparent to those skilled in the art after considering the specification and the accompanying drawings which disclose preferred embodiments thereof. All such changes, modifications, variations and other uses and applications which do not depart from the spirit and scope of the invention are deemed to be covered by this invention.

1. Method for mapping layer-3 packets over Synchronous Digital Transport Networks (SDH/SONET) and/or Optical Transport Networks (OTN), said method comprising the steps of:
setting up SDH/SONET and/or OTN connections over respective networks;
setting up a modified PPP protocol of PPP packets, without the LCP and NCP protocols for negotiation;
inserting the layer-3 packets in the modified PPP packet;
adding a GFP header of a GFP mapping layer to the the modified PPP packet, to get GFP packets;
setting a new value of UPI (User Paylod Identifier) field in the GFP header;
transmitting GFP packets so obtained over the SDH/SONET and/or OTN networks.

2. Method according to claim 1, wherein said modified PPP protocol of PPP packets comprises:
a PPP header, field Protocol, the value of which identifies the type of layer-3 payload;
the said layer-3 payload, comprising in turn an header and a payload part;
a PPP tail, field FCS, used for error checking of the PPP packet.

3. Method according to claim 1, wherein said layer-3 packets are MPLS or IP or IPX or IPv6.

4. Method according to claim 1, wherein said GFP header comprises the following fields:
PLI: payload length indication;
HEC: Header Error Check, with the following possibilities:
cHEC: core HEC, check on the Header field;
tHEC: type HEC, check on the Type field;
eHEC: extension HEC, check on the Extension header;
PTI: Payload Type identifier;
PFI: Payload FCS identifier;
EXI: Extension Header identifier;
UPI: User Payload identifier: the said new value of UPI.
